(19) United States
(12) Patent Application Publication
(10) Pub. No.: US 2008/0235422 A1
(43) Pub. Date: Sep. 25, 2008

(54) DOWNSTREAM CYCLE-AWARE DYNAMIC INTERCONNECT ISOLATION

(76) Inventors: Dhinesh Sasidaran, (US); Deo Song Chin, (US); Lee Chee Siong, (US)

Correspondence Address: INTEL CORPORATION;c/o INTELLEVATE, LLC, P.O. BOX 52050, MINNEAPOLIS, MN, 55402, US

(21) Appl. No.: 11/690,721

(22) Filed: Mar. 23, 2007

(51) Int. Cl. G06F 13/36

(52) U.S. Cl. 710/113

(57) ABSTRACT

A device, method, and system are disclosed. In one embodiment, the device includes a data reception unit that receives data from an interconnect, and a data suppression unit that receives a target address from the interconnect, determines if the target address is local to the device, and, if the target address is not local to the device, the data suppression unit suppresses the interconnect from switching at the interconnect entry point into the data reception unit.

### FIELD OF THE INVENTION

The invention relates to interconnects. More specifically, the invention relates to the isolation of downstream cycles on an interconnect.

### BACKGROUND OF THE INVENTION

Total Dynamic power is a direct result of switching activity at the input and output of a gate. Switching activity refers to the charging (to Vdd; i.e. the positive supply voltage) and discharging (to Vss; i.e. ground or negative supply) of each wire capacitance of an interconnect resulting in the transmission of either ones or zeros across the interconnect. Total Dynamic power consists of output load switching power (due to charging and discharging the output load capacitances), short-circuit power (due to finite rise and fall time of the input signal resulting in direct current path from Vdd to Vss) and internal switching power (due to charging and discharging of internal gate capacitances) One method of reducing this form of power consumption is by directly suppressing any unwanted switching activity at the input of a gate. Reducing the switching activity at the input of a gate will indirectly reduce the switching activity at the output of that gate.

Current chipset architecture in computer systems commonly uses a shared interconnect topology on its downstream path. In many embodiments, the downstream path includes the interconnect path from the interconnect controller located within the chipset to devices also within the chipset. In other embodiments, the downstream path also includes the interconnect path from the controller within the chipset to devices external to the chipset. Embodiments of an “interconnect” discussed in the specification refer to both an interconnect internal to a chipset and an interconnect external to a chipset unless specifically noted. Any address and data bus cycles running downstream will be broadcasted on the command/address interconnect and subsequently decoded by every device attached to the interconnect. Upon decoding, only one device at a time will accept the downstream cycle and participate in the resulting data transfer.

With the current shared interconnect topology, every device will be the involuntary recipient of the interconnect switching activity associated with the data transfer to another device. This switching activity results in undesired power consumption on those interfaces not currently involved in the data transfer. This unwanted power consumption increases with the addition of more devices attached to the interconnect, with an increase in clocking frequency of the data path, and with increases in interconnect width aimed to handle any desired increase in throughput.

Many different computing environments are becoming more dependent on saving power. On mobile platforms, lower power consumption means longer battery life. In server farms, lower power consumption per platform can significantly reduce the overall electricity cost when multiplied by the large number of server platforms running simultaneously. Reducing power consumption is vital in many computing environments that need to comply with energy regulatory commissions such as EnergyStar. Furthermore, lower power consumption also leads to more efficient and less costly thermal solutions and packaging costs for any given platform. Power savings which, are local to any component in the platform directly translates to global power savings at the platform level.

### BRIEF DESCRIPTION OF THE DRAWINGS

The present invention is illustrated by way of example and is not limited by the figures of the accompanying drawings, in which like references indicate similar elements, and in which:

FIG. 1 describes one embodiment of a downstream cycle-aware device capable of interconnect isolation.

FIG. 2 describes another embodiment of a downstream cycle-aware device capable of interconnect isolation.

FIG. 3 <description of embodiment with data local data bus suppression>

FIG. 4 describes an embodiment of a system including multiple devices with data suppression units coupled to an interconnect.

FIG. 5 illustrates a timing diagram of one embodiment of a transaction across an interconnect in a system that utilizes a downstream dynamic interconnect isolation scheme.

FIG. 6 is a flow diagram of one embodiment of a process isolate an interconnect to the target of a downstream data cycle.

### DETAILED DESCRIPTION OF THE INVENTION

Embodiments of a device, method, and system for downstream cycle-aware dynamic interconnect isolation are described. In the following description, numerous specific details are set forth. In other instances, well-known elements, specifications, and protocols have not been discussed in detail in order to avoid obscuring the present invention.

References to “one embodiment”, “an embodiment”, “example embodiment”, “various embodiments”, “some embodiments”, “many embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled”, along with its derivatives, may be used. In particular embodiments, “coupled” is used to indicate that two or more elements co-operate or interact with each other, but they may or may not be in direct physical or electrical contact.

A cycle refers to a phase of a transaction on an interconnect. On an interconnect that is utilizing a broadcast protocol, a transaction between an interconnect controller and a device coupled to the interconnect has at least an address phase and a data phase. The address phase is a cycle on an interconnect that broadcasts the address to notify all devices coupled to the interconnect which device is the actual target of the transaction. After the address phase, the data phase comes next and data is broadcast across the interconnect to be utilized by the target device. In a data cycle-aware device, the device is aware after the address phase whether it is the target of the data phase and performs one or more processes to get ready to either receive the data or eliminate the data phase (i.e. the interconnect switching activity) from even appearing on the interconnect from the devices point of view.

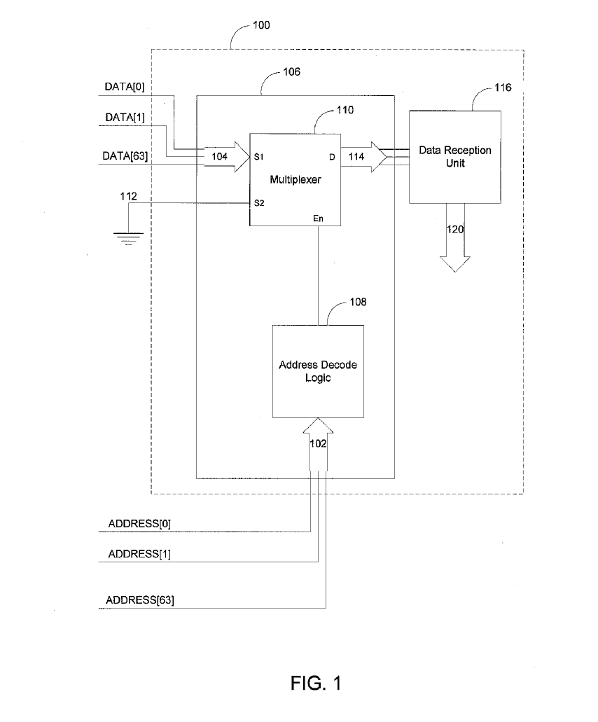

FIG. 1 describes one embodiment of a downstream cycle-aware device capable of interconnect isolation. The device 100 is coupled to an address/data interconnect. In many embodiments, the interconnect employs a broadcast protocol. A Universal Serial Bus (USB) interconnect is one example of an interconnect that uses a broadcast protocol. Another example of an interconnect that uses a broadcast protocol is a Peripheral Component Interface (PCI) interconnect. A broadcast protocol interconnect broadcasts all transactions to all devices coupled to the interconnect. Thus, even if a certain device is not the target recipient of a transaction, that device will still receive address and data information from the interconnect. In some embodiments, the interconnect may be a serial interconnect, in other embodiments, the interconnect may be a parallel interconnect.

Device 100 receives address information from interconnect address lines 102 (ADDRESS[0]-ADDRESS[63]) and receives data information from interconnect data lines 104 (DATA[0]-DATA[63]). In many embodiments, the address and data lines that arrive at device 100 are the same lines and address information and data information are received at different cycles. FIG. 1 shows separate address and data lines entering device 100, but the lines are only representational of where the address and data information is sent. Thus, in some embodiments, interconnect address lines 102 and interconnect data lines 104 may also be viewed as the same lines that are split and routed to two separate destinations, one for the address phase and one for the data phase of a transaction. Additionally, in different embodiments, any logical address/data interconnect width can be utilized by device 100 (e.g. 16-bit, 32-bit, 64-bit, 128-bit, 512-bit, etc.). The example in FIG. 1 shows a 64-bit wide address/data interconnect.

In multiple embodiments, the interconnect address and data lines (102 and 104) are routed into a data suppression unit 106 within device 100. Multiple circuits utilized to suppress switching activity are located within the data suppression unit 106. The address lines 102 are routed to address decode logic 108 and the data lines are routed to a multiplexer 110. When a transaction is broadcast across the interconnect, a target address is sent to notify which device coupled to the interconnect is the target of the transaction. In the embodiment in FIG. 1, the target address arrives across the address lines 102 at address decode logic 108. The address decode logic 108 within device 100 decodes the address that arrives on the interconnect and compares the decoded address to the address range local to device 100. A select signal line is routed from address decode logic 108 to multiplexer 110 at the En input. If the address is local, address decode logic 108 sends a select bit “1” (Sel) to the En input. If the address is not local, in other words, the transaction is not targeting device 100, then address decode logic 108 sends a not select bit “0” (Sel) to the En input. The En input is a single bit binary signal. In other words, the select signal line is asserted if the address is local, and the select signal line is deasserted if the address is not local.

Additionally, multiplexer 110 receives the data lines 104 into input S1. In one embodiment, input S2 is tied to ground 112. In different embodiments, input S2 may be tied to Vss, Vdd, or any other steady state signal available. If address decode logic 108 sends the select bit to multiplexer 110, the information subsequently transmitted over data lines 104 will be passed through multiplexer 110 and transmitted across internal data lines 114 to data reception unit 116. If address decode logic 108 sends the not select bit to multiplexer 110, the information subsequently transmitted over data lines 104 will not be allowed to pass through multiplexer 110. Instead, in this case, input S2, the steady state signal, will be passed through multiplexer 110 and transmitted across internal data lines 114 to data reception unit 116. In this example, regardless of what information is passed across the interconnect, the data reception unit 116 does not see it and instead only receives a steady state signal as input.

In one embodiment, data reception unit 116 comprises a series of latches, which consist of a series of gates, to latch the data from the interconnect. Once data reception unit 116 successfully latches the data, it can pass the valid data along to other circuitry within device 100 over internal interconnect 120. In other embodiments, other types of gating circuitry comprising gates are coupled to the interconnect. Any gate coupled to the interconnect will show power reduction if the switching activity on the interconnect is reduced.

Thus, by coupling a device with a data suppression unit to the interconnect, such as device 100, information being transmitted across the interconnect can be isolated to arrive only at the interconnect entry point into the data reception unit on the device that is the actual target of the data. The interconnect entry point into the data reception unit is represented by internal interconnect lines 114 in FIG. 1. Any, non-targeted device will have all information on the interconnect suppressed. This allows for the gating circuitry within the data reception unit to receive a minimized amount of switching activity. The circuitry in the data suppression unit 106 allows the downstream device (i.e. a device on the receiving end of the broadcast transactions) to be aware of the cycles broadcast across the interconnect and that, in turn, allows switching activity on the interconnect due to the transaction to be isolated to the target device.

Unnecessary switching on the data lines results in greater dynamic power consumption in the device because the gates that comprise the gating circuitry, which are designed to receive bits of data from the interconnect, are affected by the switching activity at the gates. If the interconnect data lines entering the gates are held to a steady state signal, the dynamic power consumption will be reduced.

In many different embodiments, downstream cycle-aware devices capable of interconnect isolation may be utilized in many different chipsets and other control devices within the computer industry. Virtually any device coupled to an interconnect that receives cycles across the interconnect with an address phase and at least one other phase may allow interconnect isolation. An address phase is required to determine the target of the transaction, but, in some embodiments, the subsequent phase on the interconnect does not necessarily need to be a data phase for isolation purposes.

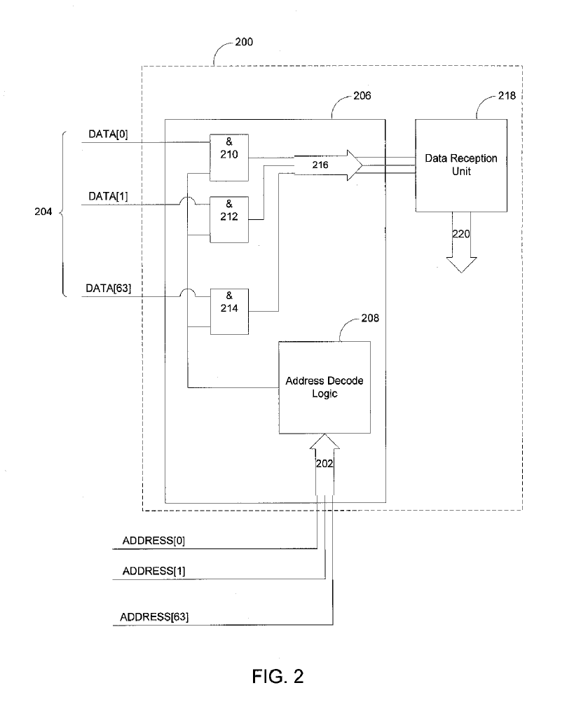

FIG. 2 describes another embodiment of a downstream cycle-aware device capable of interconnect isolation. The device 200 is coupled to an address/data interconnect with a broadcast protocol.

Device 200 receives address information from interconnect address lines 202 (ADDRESS[0]-ADDRESS[63]) and receives data information from interconnect data lines 204 (DATA[0]-DATA[63]). Again, in many embodiments, the address and data lines that arrive at device 200 are the same lines and address information and data information are received at different cycles. FIG. 2 shows separate address and data lines entering device 200, but the lines are only representational of where the address and data information is sent. Thus, in some embodiments, interconnect address lines 202 and interconnect data lines 204 may also be viewed as the same lines that are split and routed to two separate destinations, one for the address phase and one for the data phase of a transaction. Additionally, in different embodiments, any logical address/data interconnect width can be utilized by device 200 (e.g. 16-bit, 32-bit, 64-bit, 128-bit, 512-bit, etc.). The example in FIG. 2 shows a 64-bit wide address/data interconnect.

In multiple embodiments, the interconnect address and data lines (202 and 204) are routed into a data suppression unit 206 within device 200. Multiple circuits used to suppress switching activity are located within the data suppression unit 206. The address lines 202 are routed to address decode logic 208 and the data lines are routed to a block of AND gates (210-214 respectively). When a transaction is broadcast across the interconnect, a target address is sent to notify which device coupled to the interconnect is the target of the transaction. In the embodiment in FIG. 2, the target address arrives across the address lines 202 at address decode logic 208. The address decode logic 208 within device 200 decodes the address that arrives on the interconnect and compares the decoded address to the address range local to device 200. If the address is local, then address decode logic 208 sends a select bit “1” to all AND gates (i.e. active high). In one embodiment, if the data arrives in 64-bit chunks, there are 64 AND gates and each gate is coupled to one interconnect data input line. If the address is not local, in other words, the transaction is not targeting device 200, then address decode logic 208 sends a not select bit “0” to all AND gates.

AND gates 0-63 each receive interconnect data lines 0-63 respectively. If address decode logic 208 sends the select bit to AND gates 0-63, the information subsequently transmitted over data lines 204 will be passed through the AND gates and transmitted across internal data lines 216 to data reception unit 218. Once data reception unit 218 successfully latches or otherwise interacts with the data, it can pass the valid data along to other circuitry within device 200 over internal interconnect 220.

If address decode logic 208 sends the not select bit to AND gates 0-63, the information subsequently transmitted over data lines 204 will not be allowed to pass through the AND gates 0-63. Instead, because the not select bit has disabled all of the AND gates, all of the gate outputs will be held low for the duration that the not select bit is being sent. Once again, in this example, regardless of what information is passed across the interconnect, the data reception unit 218 does not see it and instead only receives a steady state signal as input.

Similar to the embodiments described in FIG. 1, information being transmitted across the interconnect in the embodiments described in FIG. 2 can be isolated to arrive only at the interconnect entry point into the data reception unit on the device that is the actual target of the data.

Furthermore, although the example embodiments above in FIGS. 1 and 2 are specific to suppressing the data cycles in an interconnect transaction, there is no need to limit the embodiments to suppressing data cycles. In many other embodiments, any type of information that would be broadcast over an interconnect with a specific target device could potentially be isolated to only arrive at the target device's interconnect entry point utilizing these isolation techniques.

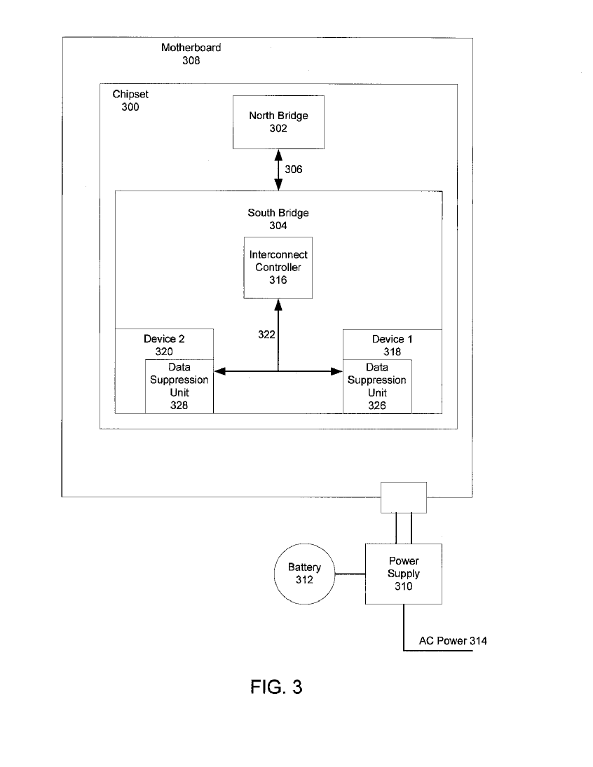

FIGS. 1 and 2 described embodiments of a device with a data suppression unit. FIG. 3 describes an embodiment of a system including multiple devices with data suppression units coupled to an interconnect internal to a chipset. In many embodiments, chipset 300 resides on a computer system. Chipset 300 may include a north bridge 302 and south bridge 304 coupled together by a hub-link 306, although embodiments of the invention are not limited in this respect. The chipset 300 is coupled to a motherboard 308. Additionally, the motherboard 308 is coupled to a power supply 310 that supplies power to devices attached to the motherboard such as, for example, one or more processors and system memory (not shown) and the chipset 300. The power supply may have power delivered to it by AC or DC current. In many embodiments, a battery 312 delivers power to the power supply. In other embodiments, the power supply may receive AC power 314.

In an embodiment, an interconnect controller 316 is located in the south bridge 304. Interconnect controller 316 is coupled to device 1 (318) and device 2 (320) through interconnect 322 . In many embodiments, interconnect controller 316 utilizes a broadcast protocol. Thus, when data is targeted to one device, both devices receive the data from the interconnect. Additionally, in many embodiments, data suppression unit 326 is located at the interconnect entry point into device 1 (318) and data suppression unit 328 is located at the interconnect entry point into device 2 (320).

When a transaction is broadcast across interconnect 320, it arrives at the data suppression unit of each device. For example, if the transaction initiated by interconnect controller 316 and device 1 (318) is the target, data suppression unit 326 (embodiments of which are described in FIGS. 1 and 2) in device 1 (318) decodes the address during the address phase of the transaction, realizes the transaction is targeting device 1 (318), and allows the subsequent data transmitted across interconnect 320 to be visible to whatever gating circuitry is coupled to interconnect 320.

Alternatively, when that same transaction targeting device 1 (318) reaches data suppression unit 328 within device 2 (320), the data suppression unit 328 decodes the address during the address phase of the transaction, realizes the transaction is not targeting device 2 (320), and does not allow the subsequent data transmitted across interconnect 322 to be visible to the gating circuitry within device 2 (320) that is coupled to interconnect 322. Thus, device 2 (320) can only see a steady state signal coming from interconnect 322 during the data phase of the transaction. FIGS. 1 and 2 describe the contents of the data suppression units in greater detail.

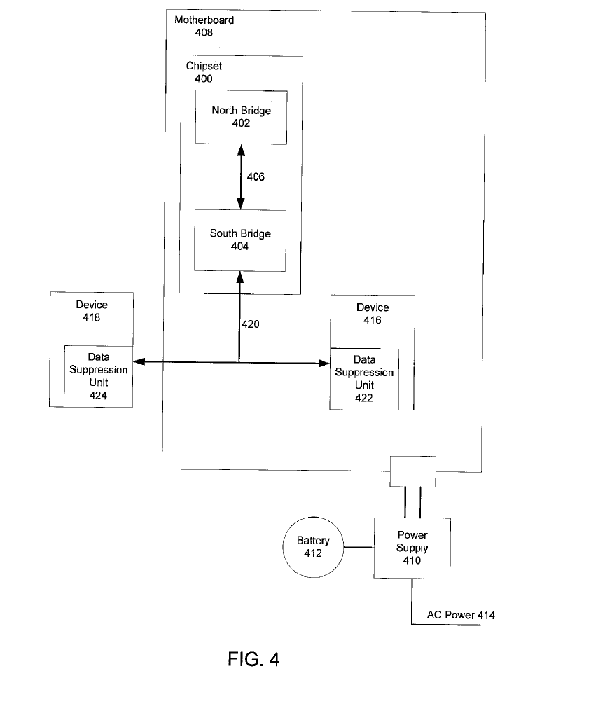

FIG. 4 describes an alternative embodiment of a system including multiple devices with data suppression units coupled to an interconnect. In many embodiments, chipset 400 resides on a computer system. Chipset 400 may include a north bridge 402 and south bridge 404 coupled together by a hub-link 406, although embodiments of the invention are not limited in this respect. The chipset 400 is coupled to a motherboard 408. Additionally, the motherboard 408 is coupled to a power supply 410 that supplies power to devices attached to the motherboard such as, for example, one or more processors and system memory (not shown), the chipset 400, and one or more I/O devices (416 and 418). The power supply may have power delivered to it by AC or DC current. In many embodiments, a battery 412 delivers power to the power supply. In other embodiments, the power supply may receive AC power 414.

In an embodiment, the south bridge 404 is coupled to I/O devices 416 and 418 by interconnect 420. In many embodiments, interconnect 420 utilizes a broadcast protocol. Additionally, in many embodiments, a data suppression unit is located at the interconnect entry point into I/O devices 416 and 418 (unit 422 for device 416 and unit 424 for device 418). In the illustrated embodiment, I/O device 416 is coupled directly to the motherboard 408 and I/O Device 418 is not attached directly to the motherboard 408. In different embodiments, depending on the type of interconnect, any percentage of the total number of devices coupled to the interconnect may be attached or not attached directly to the motherboard.

When a transaction is broadcast across interconnect 420, it arrives at the data suppression unit of each I/O device. For example, if the transaction initiated by a controller within the south bridge 404 is targeting I/O device 416, the data suppression unit (embodiments of which are described in FIGS. 1 and 2) 422 in I/O device 416 decodes the address during the address phase of the transaction, realizes the transaction is targeting I/O device 416, and allows the subsequent data transmitted across interconnect 420 to be visible to whatever latching mechanism I/O device 416 employs.

Alternatively, when that same transaction targeting I/O device 416 reaches data suppression unit 424 within I/O device 418, the data suppression unit 424 decodes the address during the address phase of the transaction, realizes the transaction is not targeting I/O device 418, and does not allow the subsequent data transmitted across interconnect 420 to be visible to the latching mechanism that I/O device 418 employs. Thus, I/O device 418 can only see a steady state signal coming from interconnect 420 during the data phase of the transaction. FIGS. 1 and 2 describe the contents of the data suppression units in greater detail.

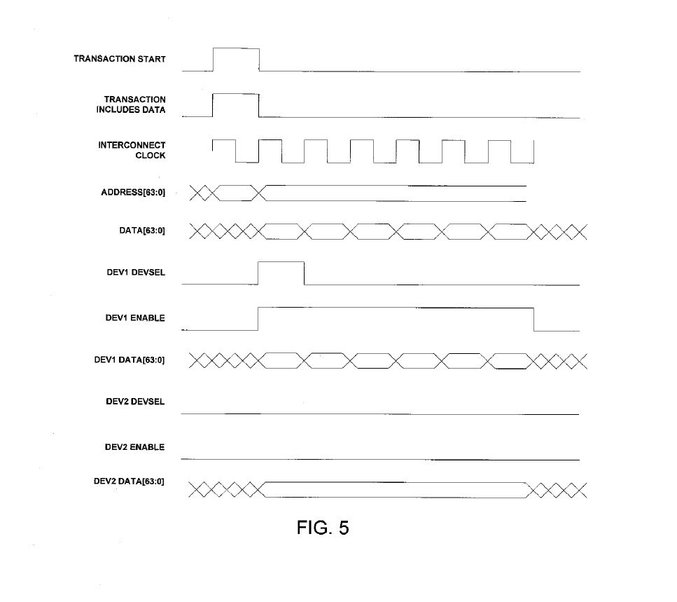

FIG. 5 illustrates a timing diagram of one embodiment of a transaction across an interconnect in a system that utilizes a downstream dynamic interconnect isolation scheme. The embodiment referred to in FIG. 5 includes an internal transaction within a chipset. The interconnect, interconnect controller, and the two devices discussed in this example are all located within the chipset. Though, in other embodiments, one or both devices may be located externally to the chipset. In these embodiments, the interconnect is routed across a motherboard or other circuit board, and both the chipset as well as the devices are coupled to the circuit board.

Returning to FIG. 5, the transaction begins by asserting the TRANSACTION START signal. The TRANSACTION START signal notifies all devices coupled to the interconnect to begin the address phase of the transaction by decoding the address presented on the interconnect.

At the same time, the TRANSACTION INCLUDES DATA signal is asserted to inform each of the devices coupled to the interconnect that there is a data phase contained in the downstream cycle of the transaction.

The target address ADDRESS[63:0] is transmitted across the interconnect when TRANSACTION START and TRANSACTION INCLUDES DATA are asserted.

In the example in FIG. 5, Device 1 (Dev1) and Device 2 (Dev2) both decode the address and determine that the target is Device 1. Thus, DEV1 DEVSEL is asserted because Device 1 has been selected. At the same time DEV1 DEVSEL is asserted, DEV1 SELECT is also asserted, allowing a transmitted interconnect transaction to pass through to gating circuitry coupling Device 1 to the interconnect. DEV1 SELECT is the signal that selects Device 1 as the target of a transmitted interconnect transaction. When DEV1 SELECT is deasserted, the gating circuitry coupling Device 1 to the interconnect sent a steady state signal only. Therefore, with Device 1 selected, Device 1 will see the switching of the data lines which represents the data transmitted during the data phase (i.e. the transmitted DATA[63:0]=DEV1 DATA[63:0] during this data phase).

Consequently, Device 2 was not selected, thus DEV2 DEVSEL is not asserted. Therefore, the DEV2 SELECT signal is never asserted during the data phase of DATA[63:0] and the result is a steady state signal for DEV2 DATA[63:0] during the data phase that shows DATA[63:0] transmitting data. As a result, the gating circuitry coupling Device 2 with the interconnect does not see any switching of the data lines for the entire data phase of the transaction.

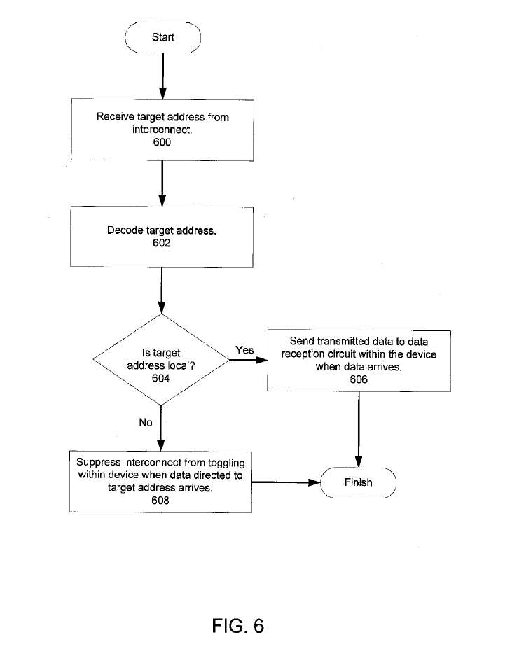

FIG. 6 is a flow diagram of one embodiment of a process isolate an interconnect to the target of a downstream data cycle. The process is performed by processing logic that may comprise hardware (circuitry, dedicated logic, etc.), software (such as is run on a general purpose computer system or a dedicated machine), or a combination of both. Referring to FIG. 6, the process begins by processing logic receiving a target address from an interconnect (processing block 600). In many embodiments, the interconnect employs a broadcast protocol. For example, in some embodiments, the transaction may be from a controller located within a chipset, across an interconnect that is coupled to the chipset, to a target device sitting out on the interconnect.

Next, processing logic decodes the target address in the address phase of the transaction (processing block 602). In some embodiments, the decoding process includes determining the actual target address information that was broadcast over the interconnect as well as a comparison of the actual target address with the range of addresses that correspond to the local device in question. The addressing scheme varies from implementation to implementation, but in many embodiments, each device connected to the interconnect will have an effective address range. Thus, any person or second device wishing to gain access to the device in question that is connected to the interconnect would send a transaction with an address in the range of addresses attributed to the target device.

Then processing logic determines if the target address is local (processing block 604). This determination utilizes the results of the decode. If the target address is local, processing logic sends the transmitted data to a data reception unit within the device once the data arrives (processing block 606). In different embodiments, the data reception unit includes gating circuitry, coupled to the interconnect, that would normally latch the data from the interconnect. Different devices may have varied implementations on how the data is processed or how the latching procedure is achieved, but the results remain the same, the device receives data from the interconnect during the data phase. In other embodiments, the gating circuitry that is coupled to the interconnect performs some functionality other than latching data from the interconnect.

Otherwise, if the target address is not local, then processing block suppresses the interconnect from switching within the device when data directed to the target address arrives (processing block 608). Each line on the interconnect, regardless of the width of the interconnect, will normally toggle many times between a binary 0 and a binary 1 during data transmission. Even when the data is not being received by the local device, the circuitry in the latching interface expends a certain amount of power due solely to the switching interconnect lines. Thus, processing logic eliminates the switching behavior by suppressing the interconnect from switching at the latching interface. Instead, processing logic sends a steady state signal to the latching interface.

Thus, embodiments of a device, method, and system for downstream cycle-aware dynamic interconnect isolation are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A device, comprising:
a data reception unit to receive data from an interconnect at an entry point; and
a data suppression unit to receive a target address from the interconnect, determine if the target address is local to the device, and, if the target address is not local to the device, suppress the interconnect from switching at the interconnect entry point into the data reception unit.

2. The device of claim 1, wherein the data suppression unit further comprises a multiplexer to:
receive the data from the interconnect;
receive a steady state signal; and
send one of the data or the steady state signal to the data reception unit.

3. The device of claim 2, wherein the data suppression unit further comprises decode logic to:
receive the target address from the interconnect;
decode the target address to determine if the target address is local to the device;
if the target address is local to the device, send a select bit to inform the multiplexer to send the data to the data reception unit; and
if the target address is not local to the device, send a not select bit to inform the multiplexer to send the steady state signal to the data reception unit.

4. The device of claim 2, wherein the steady state signal is tied to ground.

5. The device of claim 1, wherein the data suppression unit further comprises a set of AND gates, each gate to receive as input a single line from the interconnect and a select input line to transmit a select bit or a not select bit, and each gate to send as output a line to the data reception unit, wherein, if the select input line is transmitting a select bit, each gate to send as output the information received from the corresponding interconnect input line, and, if the select input line is sending a not select bit, each gate to send as output a steady state signal.

6. The device of claim 5, wherein the data suppression unit further comprises decode logic to:
receive a target address from the interconnect;
decode the target address to determine if the target address is local to the device;
if the target address is local to the device, send a select signal to each AND gate select input line; and
if the target address is not local to the device, send a not select bit signal to each AND gate select input line.

7. The device of claim 1, wherein the interconnect comprises a broadcast protocol interconnect.

8. A method, comprising:
receiving a target address from an interconnect;
determining if the target address is local to a device coupled to the interconnect; and
if the target address is not local to the device, suppressing the interconnect from switching within the device when subsequent data directed to the target address arrives across the interconnect.

9. The method of claim 8, wherein suppressing the interconnect from switching within the device further comprises forcing a steady state signal at the interconnect entry point to a data reception unit within the device that receives data from the interconnect.

10. The method of claim 8, further comprising:
receiving data from the interconnect;
receiving a steady state signal; and
sending one of the data or the steady state signal to a data reception unit.

11. The method of claim 10, further comprising:
receiving the target address from the interconnect;
decoding the target address to determine if the target address is local to the device;
if the target address is local to the device, sending data to the data reception unit; and
if the target address is not local to the device, sending the steady state signal to the data reception unit.

12. The method of claim 10, wherein the steady state signal is tied to ground.

13. The method of claim 9, wherein the interconnect comprises a broadcast protocol interconnect.

14. A system, comprising:
a point-to-point interconnect;
a sending device coupled to the interconnect;
a receiving device coupled to the interconnect, the receiving device comprising
a data reception unit to receive data from the interconnect; and
a data suppression unit to receive a target address from the interconnect, determine if the target address is local to the device, and, if the target address is not local to the device, suppress the interconnect from switching at the interconnect entry point into the data reception unit.

15. The system of claim 14, wherein the data suppression unit further comprises a multiplexer to:
receive the data from the interconnect;
receive a steady state signal; and
send one of the data or the steady state signal to the data reception unit.

16. The system of claim 15, wherein the data suppression unit further comprises decode logic to:
receive the target address from the interconnect;
decode the target address to determine if the target address is local to the device;
if the target address is local to the device, send a select bit to inform the multiplexer to send the data to the data reception unit; and
if the target address is not local to the device, send a not select bit to inform the multiplexer to send the steady state signal to the data reception unit.

17. The system of claim 15, wherein the steady state signal is tied to ground.

18. The system of claim 14, wherein the data suppression unit further comprises a set of AND gates, each gate to receive as input a single line from the interconnect and a select input line, and each gate to send as output a line to the data reception unit, wherein, if the select input line is transmitting a select bit, each gate to send as output the information received from the corresponding interconnect input line, and, if the select input line is sending a not select bit, each gate to send as output a steady state signal.

19. The system of claim 18, wherein the data suppression unit further comprises decode logic to:
receive a target address from the interconnect;
decode the target address to determine if the target address is local to the device;
if the target address is local to the device, send a select bit to each AND gate select input line; and
if the target address is not local to the device, send a not select bit to each AND gate select input line.

20. The system of claim 14, wherein the interconnect comprises a broadcast protocol interconnect.

21. The system of claim 14, wherein the sending device comprises an input/output controller in a chipset.

22. A system, comprising:
a motherboard;
a power supply coupled to the motherboard;
a battery coupled to the power supply;
an interconnect coupled to the motherboard;
a chipset coupled to the interconnect; and
a device coupled to the interconnect, the device comprising logic to
receive a target address from the interconnect;
determine if the target address is local to the device; and
if the target address is not local to the device, suppress the interconnect from switching within the device when subsequent data directed to the target address arrives across the interconnect.

23. The system of claim 22, wherein to suppress the interconnect from switching within the device further comprises forcing a steady state signal at the interconnect entry point into a data reception unit within the device that receives data from the interconnect.

24. The system of claim 22, wherein the device:
receives data from the interconnect;
receives a steady state signal; and
sends one of the data or the steady state signal to a data reception unit.

25. The system of claim 24, wherein the device:
receives the target address from the interconnect;
decodes the target address to determine if the target address is local to the device;
if the target address is local to the device, sends the data to the data reception unit within the device; and
if the target address is not local to the device, sends the steady state signal to the data reception unit within the device.

26. The system of claim 24, wherein the steady state signal is tied to ground.

27. The system of claim 22, wherein the interconnect comprises a broadcast protocol interconnect.
